(19) United States
(12) Patent Application Publication
(10) Pub. No.: US 2012/0139542 A1
(43) Pub. Date: Jun. 7, 2012

(54) SUBSURFACE WATER CHANNEL DETECTION

(75) Inventors: Jerry Montgomery, West Jordan, UT (US); Rondo Jeffery, Roy, UT (US)

(73) Assignee: WILLOWSTICK TECHNOLOGIES, LLC, Draper, UT (US)

(21) Appl. No.: 12/959,172

(22) Filed: Dec. 2, 2010

(51) Int. Cl. G01V 3/18

(52) U.S. Cl. 324/324

(57) ABSTRACT

A system for detecting a location of a subsurface water channel includes an anchor electrode for disposal in a first body of water and a mobile electrode for disposal in a second body of water. An electric current source can be coupled to at least one of the mobile electrode and the anchor electrode to generate an electric current between the mobile electrode to the anchor electrode. A lead line can be coupled to the mobile electrode to enable the mobile electrode to move a distance in the second body of water. An ammeter can be coupled to the anchor electrode to measure the electric current from the mobile electrode. A processor can compare the current with the length of the lead line to determine the location of the subsurface water channel.

### BACKGROUND

Current techniques for tracking groundwater or subsurface water flows typically involve indirect geophysical methods such as various forms of galvanic resistivity, inductive electromagnetic conductivity, ground penetrating radar, or the drilling of many observation wells. Other forms of tracking and monitoring include measuring magnetic fields created by electric currents channeled through underground water pathways.

Some disadvantages of resistivity and conductivity surveys are that they are indirect methods that map general low resistivity zones in the subsurface that may or may not be associated with the particular water course in question. Further, various classical surface electrical resistivity and/or conductivity techniques map resistivity lows or conductivity highs. Such surveys are typically designed and optimized for mineral exploration where a low resistivity volume is to be detected and delineated.

Drilling is another option for identifying and/or tracking subsurface water. A drawback to drilling is that drilling does not reveal more than what is at the location of the drill hole. To establish linkage between holes a tracer solution or some geophysical continuity test is often used. In addition, drilling can miss a narrow stream of groundwater with a well and thus produce inconclusive or misleading results. Drilling is also invasive and can be cost prohibitive.

A method to map groundwater plumes using electrical resistivity tomography (ERT) and electro kinetic system (EKS) was developed which places many electrodes on the surface and in wells and measures all combinations of resistivity between them. The water or fluids are then caused to move using electro kinetics. Subsequently, the various resistivity combinations are monitored. This data is combined to create a tomography picture that results from the displacement of the plume. These methods use a large amount of data to cover a small area of investigation. The cost/effectiveness of these approaches may be unsuitable to study water leakage issues over a large area.

Despite the development of the various technologies listed, as well as others not listed, tracking subsurface water flow remains a challenging task. For example, many technologies are directed at mapping an aqueous system, but are not as useful if a structure of the aqueous system is already known.

### SUMMARY

The present technology includes systems and methods for detecting a location of a subsurface water channel. A system according to an example includes an anchor electrode for disposal in a first body of water and a mobile electrode for disposal in a second body of water. A current source can be coupled to at least one of the mobile electrode and the anchor electrode to generate an electric current between the mobile electrode to the anchor electrode. A lead line can be coupled to the mobile electrode to enable the mobile electrode to move a distance in the second body of water. An ammeter can be coupled to the anchor electrode to measure the current from the mobile electrode. In one specific embodiment, a processor can compare the current with the length of the lead line to determine the location of the subsurface water channel.

In accordance with another example of the present technology, a system for detecting a location of a subsurface water channel includes an anchor electrode for disposal in a first body of water and mobile electrodes for disposal in a second body of water. The mobile electrodes can include a current electrode, a lead potential electrode, and a lag potential electrode. A current source can be coupled to the current electrode to generate an electric current from the current electrode to the anchor electrode. A lead line can be coupled to the mobile electrode to enable the mobile electrode to move a distance in the second body of water. A voltmeter can be coupled to the lead potential electrode and the lag potential electrode to measure voltage between the lead potential electrode and the lag potential electrode. This voltage will change based on a direction and a level of the electric current. In one specific embodiment, a processor can be used to compare the voltage with the length of the lead line to determine the location of the subsurface water channel.

In accordance with another example of the present technology, a method for detecting a location of a water pathway deviation includes disposing an anchor electrode in a first body in fluid communication with the water pathway deviation. A mobile electrode can be disposed in a flowing second body of water in fluid communication with the water pathway deviation. An electric current can be generated between the mobile electrode and the anchor electrode along the water pathway deviation. The mobile electrode can be moved with a fluid flow in the flowing second body of water and along a distance in the flowing second body of water past the water pathway deviation. Changes in electric current between the mobile electrode and the anchor electrode can be measured as a function of the distance.

In accordance with another example of the present technology, a method for electric admittance mapping using moving electrodes to detect a location of a water pathway deviation includes disposing an anchor electrode in a first body in fluid communication with the water pathway deviation. Mobile electrodes can be disposed in a flowing second body of water in fluid communication with the water pathway deviation. The mobile electrodes can include a current electrode, a lead potential electrode, and a lag potential electrode. The method can include generating a current between the current electrode and the anchor electrode along the water pathway deviation and moving the mobile electrodes with a fluid flow in the flowing second body of water and along a distance in the flowing second body of water past the water pathway deviation. A potential difference can be measured across the lead potential electrode and the lag potential electrode as a function of the distance.

In accordance with another example of the present technology, a method for electric admittance mapping using moving electrodes to detect a subsurface water pathway includes disposing an anchor electrode in a first body of water and disposing mobile electrodes in a second body of water. The mobile electrodes can include a current electrode, a lead potential electrode, and a lag potential electrode. A current can be generated between the current electrode and the anchor electrode along the subsurface water pathway. The mobile electrodes can be moved along a distance in the second body of water past the subsurface water pathway. The method can also include measuring a potential difference across the lead potential electrode and the lag potential electrode as a function of the distance.

### BRIEF DESCRIPTION OF THE DRAWINGS

FIG. 1 is a system for detecting a subsurface water channel in accordance with an embodiment of the present technology;

FIG. 2 is a graph of an electrical current as a function of distance as a mobile electrode of FIG. 1 is moved across a water leak;

FIG. 3 is a mobile electrode assembly including lead and lag potential electrodes in accordance with an embodiment of the present technology;

FIG. 4 is a graph of a measured potential difference of the lead and lag potential electrodes of FIG. 3;

FIGS. 5a-5b are combined graphs of a measured electrical current and potential difference in accordance with an embodiment of the present technology;

FIGS. 6-7 are electrodes including metal spheres in accordance with an embodiment of the present technology;

FIG. 8 is a system for detecting a subsurface water channel in accordance with an embodiment of the present technology;

FIG. 9 is a measurement and recording system for measuring, recording, and processing data for detecting a subsurface water channel in accordance with an embodiment of the present technology;

FIGS. 10-12 are flow diagrams of methods for detecting a subsurface water channel in accordance with embodiments of the present technology;

FIG. 13 illustrates detecting a subsurface water channel from a canal in accordance with embodiments of the present technology;

FIG. 14 illustrates detecting a subsurface water channel from a dike in accordance with embodiments of the present technology;

FIG. 15 illustrates a system for detecting a seepage location from a canal using a mobile anchor electrode and a mobile electrode assembly in accordance with embodiments of the present technology; and

FIG. 16 includes graphs of signature electric current and voltage measurements across a wide or narrow seepage, and across greater or lesser seepage in accordance with embodiments of the present technology.

### DETAILED DESCRIPTION

Reference will now be made to the exemplary embodiments illustrated, and specific language will be used herein to describe the same. It will nevertheless be understood that no limitation of the scope of the technology is thereby intended. Additional features and advantages of the technology will be apparent from the detailed description which follows, taken in conjunction with the accompanying drawings, which together illustrate, by way of example, features of the technology.

Systems and methods for electric admittance mapping using moving electrodes to detect subsurface water pathways are described. In general, electric admittance mapping is performed by moving at least one current electrode in a water body and/or water flow relative to another electrode another water body/flow in fluid communication with the first water body/flow. According to an example, electric admittance mapping involves measuring a flow of electric current between the electrodes as the current electrode is moved relative to the other electrode. According to another example, the electric admittance mapping involves measuring a voltage across electrodes near the current electrode.

This technology may be used in an underground water tunnel or an underground city water main. In large cities, tunnels can extend for miles and searching for the leak using this technology could result in substantial time and costs savings.

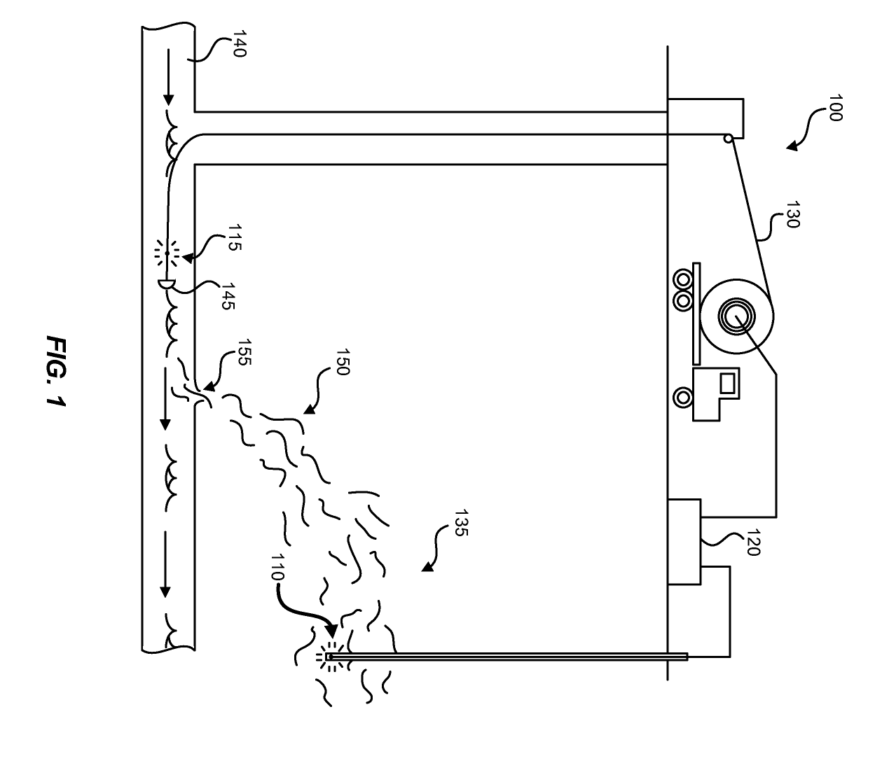

Referring to FIG. 1, a system 100 for detecting a location of a subsurface water channel 150 is illustrated in accordance with an example. The system includes an anchor electrode 110 for disposal in a first body of water 135. As used herein, the term “anchor electrode” refers to an electrode which serves as a base for receiving or transmitting an electric current, signal, or voltage. Thus, “anchor” refers to a base for transmitting or receiving rather than a fixation of location. Accordingly, an anchor electrode may be anchored or fixed in a desired location, or the anchor electrode may be mobile.

In FIG. 1, the first body of water is a subsurface body of water caused by a leak in an underground water tunnel 140, which may be considered a second body of water into which a mobile electrode 115 can be placed. The subsurface water channel is the fluid connection between the first body of water and the second body of water. For example, the second body of water can be an underground water tunnel, the subsurface water channel can be water leaking from the tunnel at a leak 155, and the first body of water can be a well or spring caused by the leak. Water can leak from the tunnel, through the ground, and into the well. The well may be a well dug specifically for identifying the location of the leak in the tunnel, or may be a pre-existing well which is receiving water leaking from the tunnel. In other examples, the first body of water can be a surface body of water, such as a spring. As used herein, “detecting a location of a subsurface water channel” means to detect a location where water leaks or otherwise deviates from a desired or expected course. Thus, although the subsurface water channel may extend from a leak or deviation point in the tunnel to the well, detecting the location of the channel means detecting the point of deviation and not necessarily the location of the entire channel.

An electric current source (included in box 120) can be coupled to at least one of the mobile electrode 115 and the anchor electrode 110 to generate a current between the mobile electrode and the anchor electrode. The electric current can be a direct current (DC) or an alternating current (AC). The DC electric current source may be a constant DC current source or a pulsed DC current source. The signal can be enhanced by using a source that is time or frequency locked to the receivers.

Use of a signature electric current can aid in distinguishing this electric current from any other electric current or background noise. The received signal can also be filtered for noise. There are two dominant sources of electrical noise in the subsurface. The first source is from power companies which use the earth as a return circuit for power distribution. Thus, as load changes, the unbalanced electric current will be discharged to the ground. Another noise source is from telluric currents created by the solar wind bombarding the earth ionosphere. These effects can be screened by frequency locks between a transmitter and receiver.

The mobile electrode 115 can be moved along the second body of water 140 (e.g., within the tunnel of FIG. 1). A measurement system (included in box 120) can include an ammeter coupled to the anchor electrode to measure the electric current from the mobile to the anchor electrode. As the mobile electrode is moved along a distance in the tunnel towards the leak 155, the electrical current between mobile and the anchor electrode can increase to a peak current where the mobile electrode is at the leak. As the mobile electrode is moved along a distance in the tunnel past the leak, the electrical current can decrease to a normal level.

The mobile electrode 115 can be coupled to a lead line 130. The lead line can enable the mobile electrode to be moved in a controlled manner along a distance in the second body of water 140. The lead line can also include an electrical connection (included in box 120) for supplying or measuring an electric current. A head 145 can be coupled to the lead line near the mobile electrode to enable the mobile electrode to float or otherwise move along the second body of water. For example, the head may comprise a buoyant material or specific shape for a given application. As another example, the head can include fins extending outwardly from the lead line such that the flow of water will impel the head (and thus the mobile electrode) along through the water.

The measurement system (included in box 120) can include a line meter to measure a length of a lead line coupled to the mobile electrode as the mobile electrode is moved along the tunnel The measurement system can also include a processor operable to compare the electric current with the length of the lead line to determine the location of the subsurface water channel. In other words, the system can identify where the peak current occurred in terms of length of the lead line. Since the path of the tunnel is known, the length of the lead line at the peak can be compared against the tunnel path to identify where along the tunnel path water deviated from the path. Thus, when attempts are made to repair the tunnel, workers can quickly identify and repair the leak in the tunnel

Though the example of FIG. 1 illustrates a system used for identifying a subsurface water pathway from an underground water tunnel, other uses can also be implemented. The system can be used to detect water leakages in water conveyance tunnels, canals, long dikes, and so forth. Some various subsurface water connections for which the system can be used can also include targets that have a surface expression such as a seep, spring, leak in an earthen dam, leaking drain fields, or other surface expressions of subsurface water leaks. In these examples, the first electrode can be placed directly in the seep, spring, or other surface expression to energize directly the concerned fluid. The second electrode can provide an origination path for the energizing current measurable at the first electrode. A power source providing electrical energy at a predetermined, constant frequency and voltage is connected between the current electrodes. Some various subsurface water connections for which the system can be used can also include targets with no surface expression. These examples may involve the use of a well, drilled hole, and the like. Some specific example uses will be described in further detail below.

The electric current between the mobile electrode and the anchor electrode can be used to map, track, and/or monitor a subsurface deviation from an aqueous system (i.e., ground water solutions, and related geologic structure). The technology can use a precisely controlled electrical current introduced into a groundwater solution of interest. The electric current flows in the groundwater conductor. The changes in the electric current and variations of the current with time and/or distance can be used to map and monitor leaks, deviations, and even other activity such as seasonal fluctuations, pumping, in situ leaching, chemical or biological reactions that are taking place in subsurface solutions. These properties can be measured using surface readings. Because this technology directly energizes the target horizon there is confirmation that the signal being measured is coming from the designated or desired target.

The measurement of the electric current between the mobile electrode and the anchor electrode can be described as a measurement of the electric admittance between the two electrodes through the subsurface water pathway. A constant voltage can be applied across the two electrodes and the resulting electric current is measured. The electric current measured can be written as, I=V /(R_{wire}+R₁+R₂+K₁₂), where R_{wire} is the resistance of the wire, R₁ and R₂ are the contact resistance of electrodes 1 and 2 (i.e., the anchor electrode and the mobile electrode), and K₁₂ is the resistance between points 1 and 2 in the earth subsurface. 1/K₁₂ is the electric admittance between the two electrodes.

Because the moving electrode is in water, an assumption can be made that R₁ and R₂ are constant (do not change) during a survey. Thus the change in electric current (I) reflects the change of the electric admittance between points 1 and 2 in the earth subsurface. To maximize the changes of electric current (I) with respect to K₁₂, the resistances R_{wire}, R₁ and R₂ can be kept small. The size of the electrodes and the diameter of the wire can be selected to keep R_{wire}, R₁ and R₂ relatively small. If R_{wire}+R₁+R₂ is dominant over K₁₂, identifying changes in the electric current can be very difficult even if the water leakage makes K₁₂ very small. Water pathways between two points in the subsurface can produce high admittance (connectivity) if the host environment is more resistive than water. The bigger the contrast between water and host environment resistivity, the larger the admittance increase can be produced by subsurface water pathways. In general, the electrode resistance can be written as R_{contact}=ρ/(2 π S), where S is the dimension of the electrode and ρ is the host resistivity. If the host resistivity (ρ) is high, the S can be made large enough to keep R_{contact} small.

The system can form a circuit in a large single turn loop consisting of: the anchor electrode in the groundwater, the wire connecting the anchor electrode and the mobile electrode, the mobile electrode, and the groundwater between the electrodes. The technology is based on the concept that electrical current injected into a groundwater source will preferentially follow the groundwater because the ground water is the best available conductor. If no other factors influence the electric current, the peak electric current will identify where leakages occur. This permits the tracing and identification of the underground water pathway deviations through the use of electrical admittance mapping.

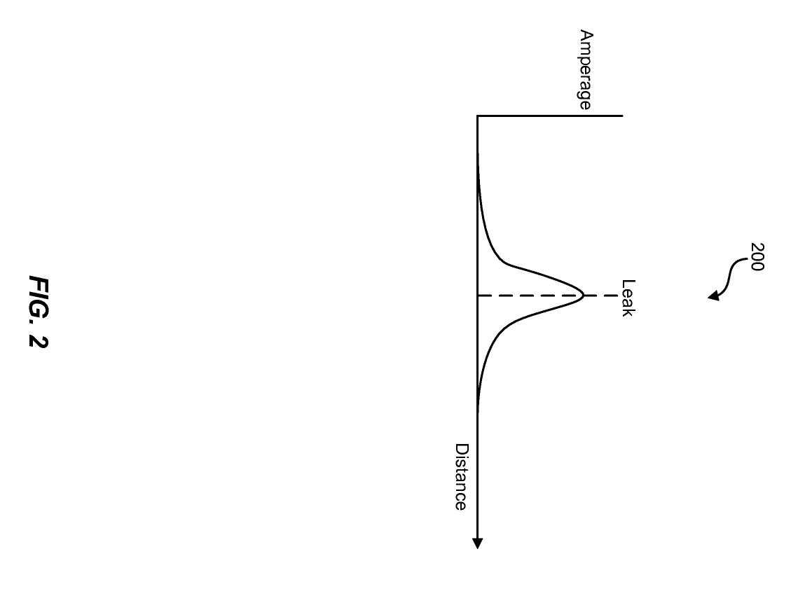

FIG. 2 illustrates a graph 200 of an electric current across a leakage, or the electric current measured as a function of distance of a lead line. The peak in electric current will occur at or substantially near the leakage point.

Pure water is a relatively poor conductor. However, groundwater and aqueous solutions are never pure water and almost always act as a good conductor in the earth's crust. This is due to the presence of dissolved ions either from natural or man-made sources. These could include but are not limited to dumped wastes products, leaking subsurface storage facilities, the creation of acid underground, chemical reactions occurring subsurface, the injection of in situ leach solutions, or conductivity changes resulting from biological activity. The water being tracked may be only one of several conductors being energized or partially energized. Clay soils often act as a weak conductor producing a broad superimposed field. Nearby power lines or buried cable will produce their own fields and need to be accounted for. The depth of the water from the surface may also vary and can cause variations in the field measurements. Other potential influences include changes in ion concentration, a broadening of the water stream (sheet flow versus channel flow). Information concerning the physical properties at the site can be taken into consideration when any study is undertaken and factored into all interpretation of the data.

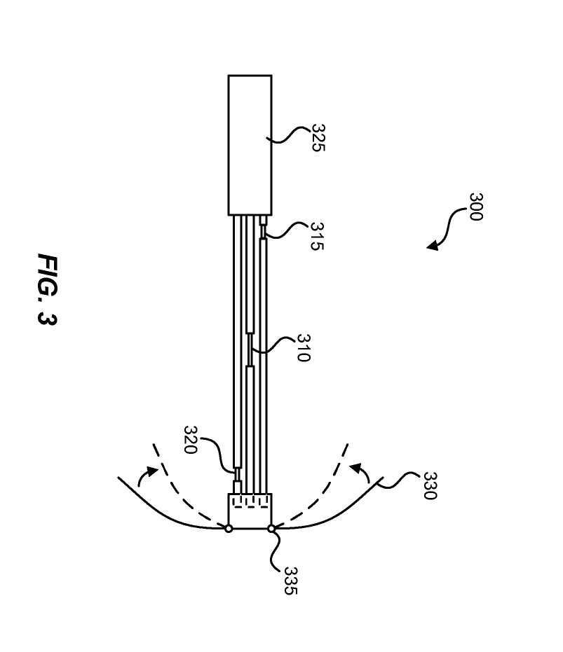

Reference will now be made to FIG. 3. To further reduce ambiguity in the data interpretation, the potential difference between two points that are leading and lagging the current electrode can be measured. This measurement can be in place of the measurement of the electric current, as described regarding FIG. 1 above, or can be together with the measurement of the electric current. The measurement of the potential difference can aid in diagnosing that the electric current increase over a portion of a tunnel is indeed due to a lateral leakage. Lateral leakage would increase the electric current and generate a potential difference cross-over in the same lateral scale length. The relationships of the current increase and potential cross-over can provide further information with regard to leakage amplitude, lateral interval, direction, etc. An inversion method can provide quantitative information on the leakage amplitude, lateral interval, direction, etc. A modeling study can establish the baseline of the current and potential distribution without any water leakage. Such baseline behaviors can be used to remove misleading geometric effects from the data. Variations of the electric current and potential difference with regard to the position of the electrode assembly in the tunnel can also be established.

The electrode assembly 300 shown in FIG. 3 is a mobile electrode assembly at an end of a lead line for controlling the movement of the mobile electrode assembly along a body of water. The electrode assembly includes a current electrode 310, a lead potential electrode 320, and a lag potential electrode 315. In one aspect, the current electrode can be coupled to a heavy duty wire and the lead and lag potential electrodes can be coupled to light duty wires. Polarity of the current injection to the current electrode can be changed to eliminate a static (self-) potential between the electrodes.

The three electrodes can be enclosed in a sheath 325 or antenna cable inside the lead line and can have an exposed or active portion (shown as electrodes 315, 310, 320). Though in actuality the electrodes may extend along an entire length of the lead line, for purposes of this discussion, the electrodes will be considered as the exposed portions of the wires. In a specific example, the lead and lag potential electrodes can each have an exposed portion approximately 0.25 ft in length. The current electrode can have an exposed portion approximately 4.5 ft in length. The lead and lag potential electrodes can be separated from the current electrode by approximately 15 ft. A voltage source can supply 300V across the current electrode to produce a current of approximately 1 A. Changes in the current due to water leakage as the electrode assembly moves along the body of water may typically be anticipated as between 10-100%. The change in electric current typically occurs as the electrode assembly approaches and passes a leak or water pathway deviation. For example, the electric current may begin a noticeable increase approximately 20 meters before the leak. As the mobile electrode assembly approaches the leak, the electric current can increase to a maximum at or near the leak. As the mobile electrode assembly passes the leak and moves farther away from the leak, the electric current will decrease to a normal level in approximately 20 meters. The dimensions, amperage, voltage, electric current changes, distances, and so forth are set forth as examples and may vary according to specific applications of the technology.

When the electrode assembly moves across a water leakage point, there will be an electric current increase over the leaking portion of the tunnel, and a potential difference cross-over. The combination of these features can help to eliminate false anomalies in a survey. The potential difference may typically be in the range of 1-50 mV. A voltmeter can be connected to the lead and lag potential electrodes to measure voltages between the lead and lag potential electrodes caused by the electric current in the water from the current electrodes.

As the electrode assembly 300 approaches a leak, electric current from the current electrode 310 will flow ahead or downstream of the current electrode, past the lead potential electrode 320. A voltage caused by this forward-moving electric current can be measured. As the lead potential electrode gets near to and passes the leak, the voltage can peak and begin to decrease. When the current electrode passes the leak, the current will flow backwards or upstream. Because the current is flowing in an opposite direction, the electric current can be negative and voltage measured between the lead and the lag potential electrode will change polarity. This negative voltage measured at the lag potential electrode can increase as the lag potential electrode approaches the leak. As the lag potential electrode gets near to and passes the leak, the voltage can reach a bottom and begin to increase. The point of the voltage cross-over from positive to negative can thus be correlated with the location of the leak.

The electrode assembly 300 also includes a head 330 to enable the electrode assembly to float, and to aid the electrode assembly in being impelled by a flow of water. The head can be coupled to an end of the lead line using spring-loaded hinges 335 to absorb shocks from impact with walls of a water body or impact with objects in the water. Also, the hinges can enable the head to fit through smaller or narrower water channels.

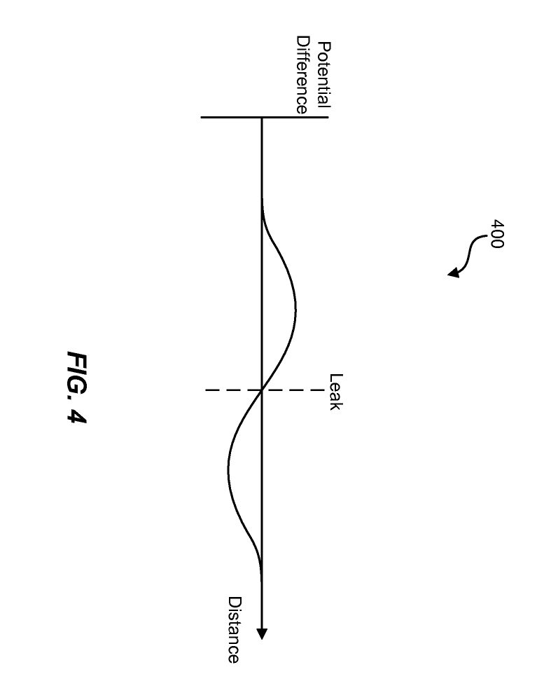

FIG. 4 illustrates a graph 400 of a measured potential difference across the lead and lag electrodes as a function of distance of a lead line as a mobile electrode assembly is moved in a body of water. The cross-over point from positive to negative voltage will occur at or substantially near the leakage point.

A system using the voltage is provided for detecting a location of a subsurface water channel between two bodies of water, or more specifically for detecting a location of a deviation point of the subsurface water channel from a first body of water in a course to a second body of water. The system includes an anchor electrode for disposal in a first body of water, and a plurality of mobile electrodes for disposal in a second body of water. The plurality of mobile electrodes includes the above-described current electrode, lead potential electrode, and lag potential electrode. The system includes a current source coupled to the current electrodes to generate an electric current from the mobile electrode to the anchor electrode. A lead line is coupled to the mobile electrode to enable the mobile electrode to move a distance in the second body of water. A voltmeter is coupled to the lead and lag potential electrode to measure the voltage between them. As described above, the voltage changes based on a direction and a level of the electric current from the mobile electrode to the anchor electrode. The system can include a processor to compare the voltage with the length of the lead line to determine the location of the subsurface water channel or deviation point.

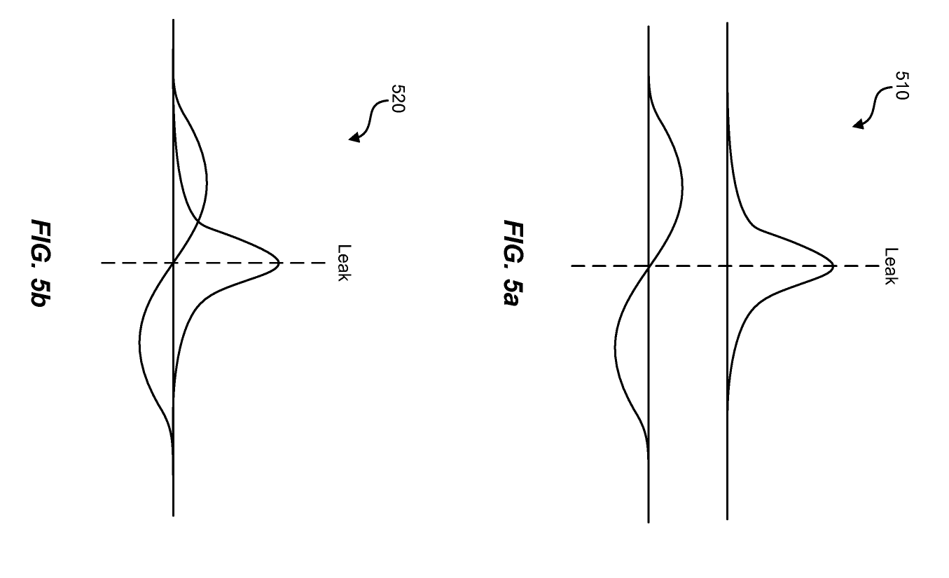

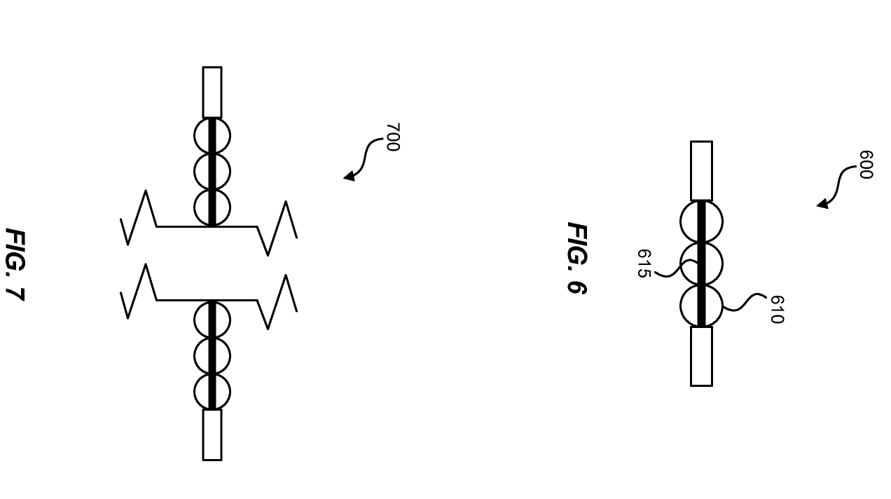

The system can use an electric current peak, a potential difference cross-over, or both, to identify a distance at which the leak or deviation occurs. The system can be configured to produce graphs 510, 520, such as those shown in FIGS. 5a-5b to compare the electric current and voltage measurements. FIG. 5a illustrates a configuration where the electric current and the voltage graphs are aligned vertically to provide a combined view of the two data measurements. FIG. 5b illustrates a configuration where the electric current and the voltage graphs are overlaid. Other configurations are also contemplated. The system can include a display, such as a computer screen, for displaying the graphs, measurements, and/or other information to a user.

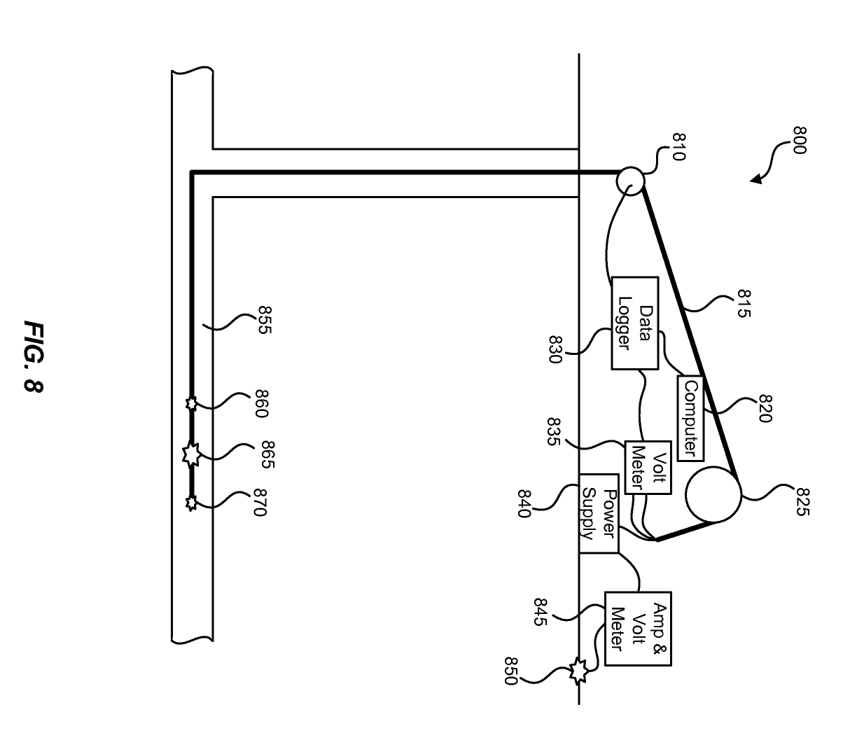

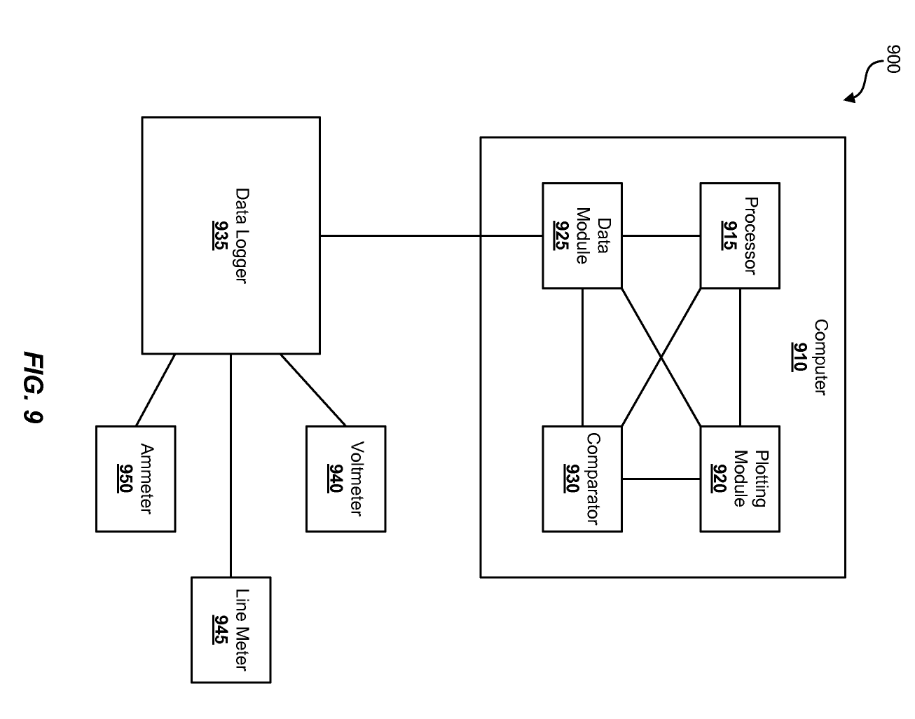

Referring to FIGS. 6 and 7, the electrodes 600, 700 described herein can include metallic spheres 610, such as stainless steel balls, or other conductive structures that would be useful for the purpose described herein. The stainless steel balls can be fit over the exposed portion of the wires 615. Use of stainless steel balls can provide a maximally effective area to guide current into the surrounding water, for example. Thus, a plurality of conductive spheres strung along the exposed portion of the wire can provide a greater surface area for enhanced conduction of electric current to water, or for measuring a voltage from an electric current flowing through the water. Use of spheres can also improve flexibility of the wire as compared with other shapes. While spheres or balls may be useful, other shapes and designs can also be used.

Each electrode may comprise one or more spheres. Because the current electrode may typically comprise a longer exposed portion of wire than the lead and lag potential electrodes, the current electrode may comprise more spheres than the lead and lag potential electrodes. Thus, FIG. 6 may represent the lead and lag potential electrodes 600 and FIG. 7 may represent the current electrode 700.

Referring to FIG. 8, a system 800 for detecting a location of a water pathway deviation is shown. An anchor electrode 850 is located in a surface expression or body of water, such as a spring. A mobile electrode assembly (including a current electrode 865, a lead potential electrode 870, and a lag potential electrode 860) is placed in a flowing water path, such as an underground tunnel 855. A lead line supply 825 provides a length of lead line 815 to be fed into the flowing water path to move the mobile electrode assembly along the flowing water path. A line meter 810 can measure a length of lead line fed into the flowing water path to ascertain a distance of the flowing water path along which the mobile electrode assembly has traveled. A power supply 840 can provide a voltage and generate an electric current from the current electrodes. An amp and volt meter 845 coupled to the power supply and to the anchor electrode can measure the voltage being supplied to the current electrodes and the resulting electric current. A same or different volt meter 835 can measure the voltage between the lead and lag potential electrodes. A data logger 830 can log measurements from the line meter, the amp and volt meter, and the volt meter. A computer 820 with a processor can read the data from the data logger and process the measurements to identify the location of the leak.

The processor may include modules to adjust phase and frequency of measured field signals, to exclude undesired frequency components from said field signals, to display processed signals, and to record measured data and processed data to a computer readable storage medium.

The power supply 840 can be a transmitter capable of generating an electrical signal of one or multiple preselected frequencies

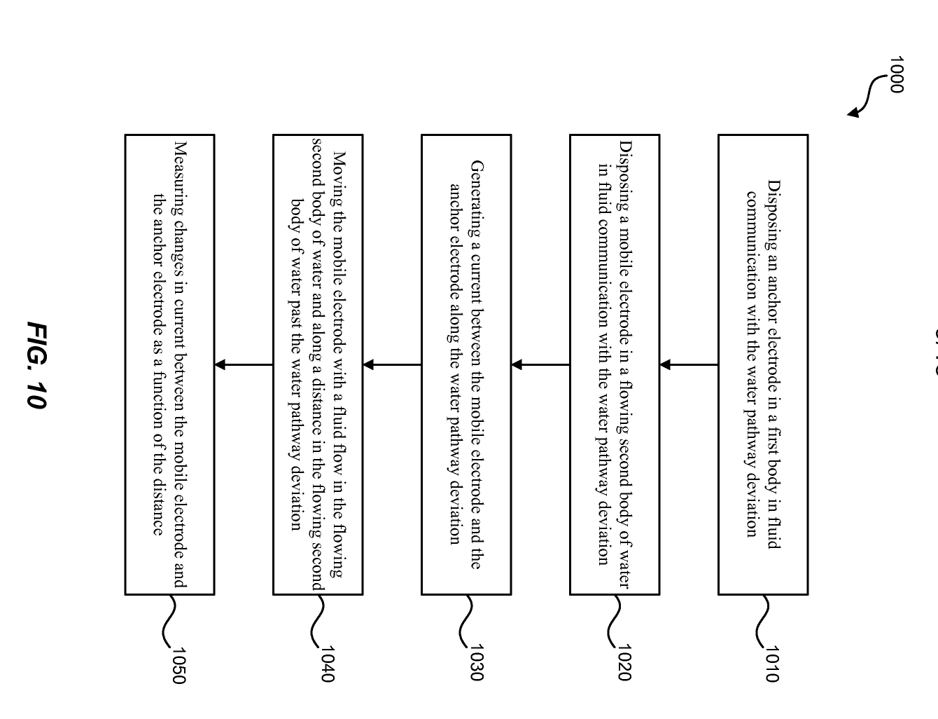

Referring to FIG. 9, a measurement and recording system 900 for use with electrodes, lead line, power supply, and other components described above is provided. A voltmeter 940, line meter 945, and ammeter 950 each provide input to a data logger 935. A computer 910 includes a data module 925 for accessing the data logged by the data logger. A comparator 930 can compare voltage using a processor 915 to determine voltage as a function of distance. A plotting module 920 can use the processor to plot graphs of electric current measurements, and/or voltage as a function of distance, as measured by the line meter.

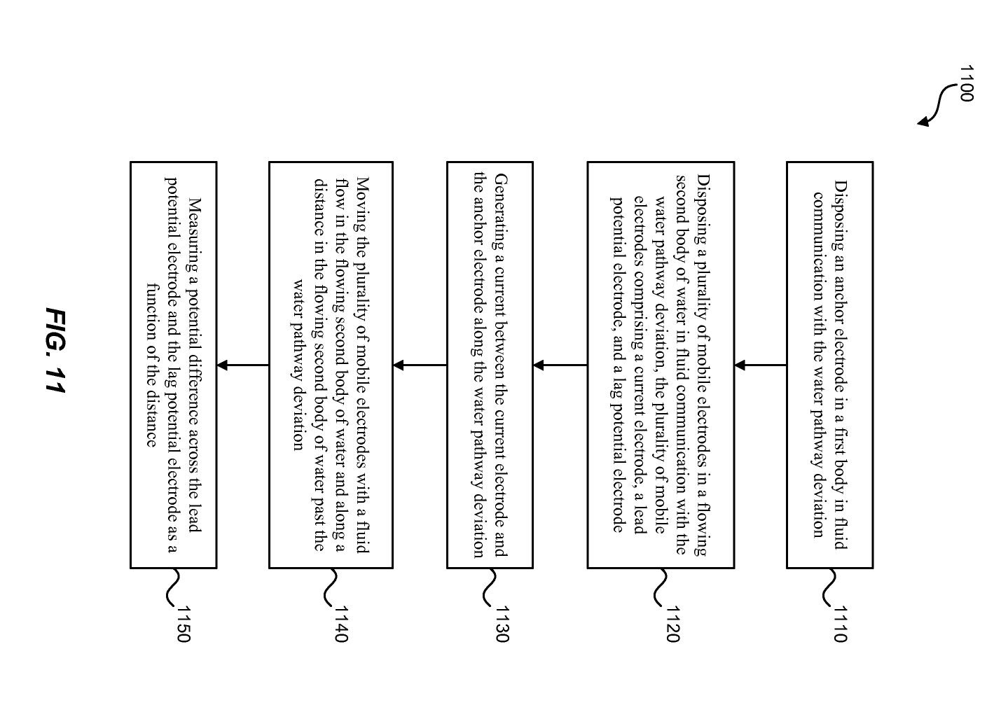

Referring to FIG. 10, a flow diagram is shown of a method 1000 for detecting a location of a water pathway deviation in accordance with an example. The method includes disposing 1010 an anchor electrode in a first body in fluid communication with the water pathway deviation. A mobile electrode can be disposed 1020 in a flowing second body of water in fluid communication with the water pathway deviation. An electric current can be generated 1030 between the mobile electrode and the anchor electrode. The mobile electrode can be moved 1040 in the flowing second body of water along a distance past the water pathway deviation. Changes in electric current between the mobile electrode and the anchor electrode can be measured 1050 as a function of the distance.

The method can include various other steps, such as mapping the electric current on a graph as a function of the distance, identifying an increase and a decrease in the electric current as a function of the distance, isolating an electric current peak, and/or identifying a leak location in the second body of water based on the distance at the electric current peak.

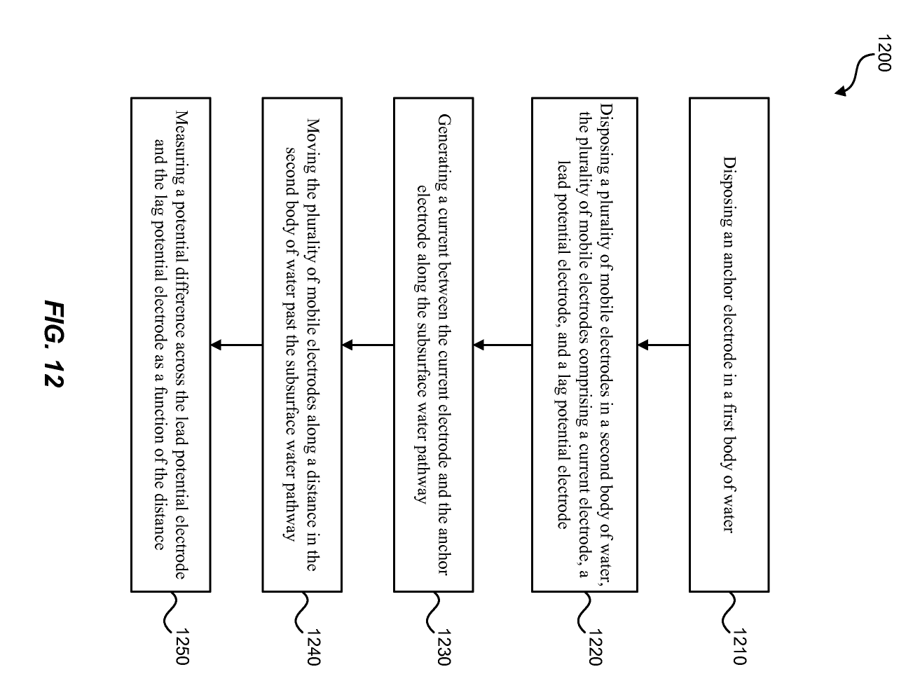

Referring to FIG. 11, a method 1100 is shown for electric admittance mapping using moving electrodes to detect a location of a water pathway deviation in accordance with another example of the present technology. The method includes disposing 1110 an anchor electrode in a first body in fluid communication with the water pathway deviation. Mobile electrodes can be disposed 1120 in a flowing second body of water in fluid communication with the water pathway deviation. The mobile electrodes can include a current electrode, a lead potential electrode, and a lag potential electrode. The method can include generating 1130 an electric current between the current electrodes and moving 1140 the mobile electrodes in the flowing second body of water and along a distance past the water pathway deviation. A potential difference can be measured 1150 across the lead potential electrode and the lag potential electrode as a function of the distance.

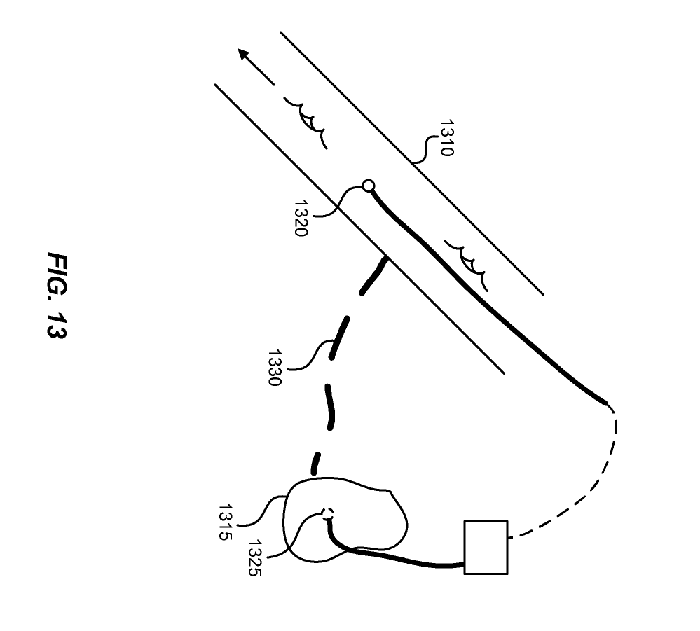

Referring to FIG. 12, another method 1200 is shown for electric admittance mapping using moving electrodes to detect a location of a water pathway deviation in accordance with another example of the present technology. The method includes disposing 1210 an anchor electrode in a first body of water and disposing 1220 mobile electrodes in a second body of water. The mobile electrodes can include a current electrode, a lead potential electrode, and a lag potential electrode. An electric current can be generated 1230 between the current electrode and the anchor electrode along the subsurface water pathway. The mobile electrodes can be moved 1240 along a distance in the second body of water past the subsurface water pathway. The method can also include measuring 1250 a potential difference across the lead potential electrode and the lag potential electrode as a function of the distance.

The method can also include one or more of the following steps:
mapping the potential difference on a graph as a function of the distance;
identifying an area of positive potential difference and an area of negative potential difference;
determining a potential difference cross-over where the positive potential difference changes to the negative potential difference;
identifying a leak location in the second body of water based on the distance at the potential difference cross-over;
measuring the electric current between the current electrode and the anchor electrode;
mapping the current on a graph as a function of distance;
identifying an increase in the current and a decrease in the current as a function of the distance;
isolating a current peak where the increase in the current stops increasing before changing into the decrease in the current;
identifying a leak location in the second body of water based on the distance at the current peak;
mapping the electric current and the potential difference together on a graph;
comparing a potential difference cross-over with a current peak as a function of the distance; and
identifying a leak location in the second body of water based on the comparison of the potential difference cross-over with the current peak.

Following are some examples of how this technology can be used in various subsurface water monitoring applications. These are presented as examples and are not intended to cover all situations involved in tracking groundwater.

1. Follow groundwater channels and/or map groundwater structures. Locations of water channel deviations can be identified using the technology.

2. Track and monitor subsurface pollution plumes. An electric current between a pollution plume and another aqueous system can be used to map the plume or otherwise identify any branches that might go undetected by a systematic drilling program.

3. Locate the source and feeder system of springs or seeps. Movement of a mobile electrode along a body of water believed to be a source of a spring can be confirmed by measuring the electric current at an anchor electrode in the spring.

4. Map interconnected fracture or porous zones. Movement of a mobile electrode along a porous zone believed to be connected another porous zone can be confirmed by measuring the electric current at an anchor electrode.

5. Map or identify the location of leaks in earthen dams, drain fields, etc. As the mobile electrode is moved along the dam, the electric current will increase and peak near a leak.

6. Monitor changes in subsurface water flow. If a leak or water pathway deviation is identified at a location, the area can be subsequently surveyed to determine if the leak or deviation still exists, or if new or additional leaks or deviations exist.

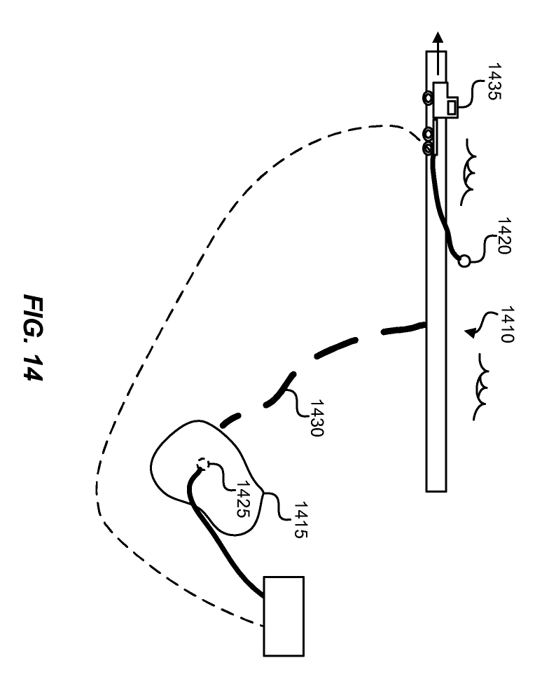

Referring to FIG. 13, an example use of the technology is illustrated for identifying an underground water pathway deviation in a canal 1310. (While the technology can also be used for identifying surface deviations, such deviations can often be easily identified without use of the technology). The arrow represents a flow direction of water in the canal. A spring 1315 is located near the canal and is fed by an underground channel 1330 from the canal. An anchor electrode 1325 is placed in the spring and a mobile electrode 1320 is moved along the canal. Using electric current measurements and/or measurements of voltage, the location of the leak or deviation in the canal can be identified.

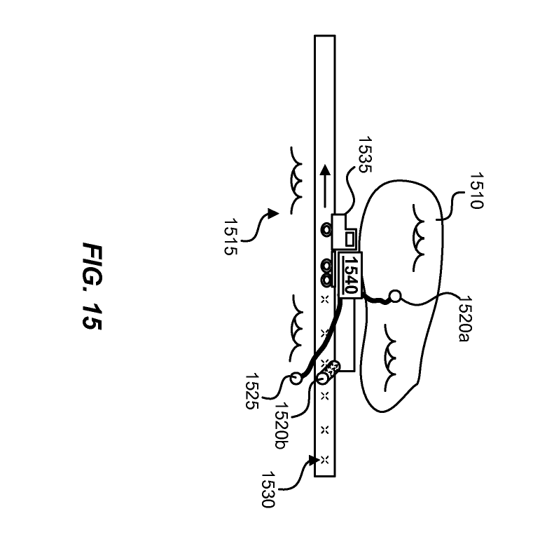

Referring to FIG. 14, an example use of the technology is illustrated for identifying an underground water pathway deviation in a dike 1410. In this example, the water in the dike is not necessarily flowing. Thus, a truck 1435 is shown pulling the mobile electrode 1420 in the water along a distance of the dike. Other means of pushing or pulling the mobile electrode are also contemplated. An anchor electrode 1425 in a different body of water 1415 detects electric current from the mobile electrode through an underground water passage 1430 as the mobile electrode is moved along the dike.

Although the examples herein describe movement of one electrode relative to a fixed or anchor electrode, the anchor electrode may also be a mobile electrode. Thus, the two mobile electrodes can each be moved, and an electric current generated across the current electrodes can be used to find water leaks.

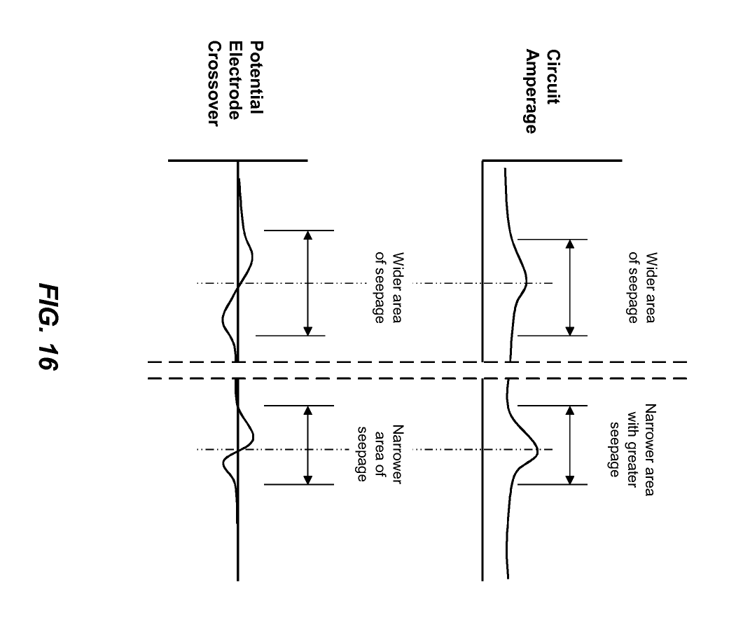

FIG. 15 illustrates example implementations of system using a mobile anchor electrode and a mobile electrode assembly. A vehicle 1535, winch, person, or any other suitable movement device may be used for pushing or pulling the mobile electrode assembly 1525 in a first body of water 1515, such as a canal. The mobile electrode assembly can include a current electrode, and can optionally also include lead and lag potential electrodes. The mobile electrode assembly can be electrically coupled to a system management unit 1540. The system management unit can include various components, such as a computer, a data logger, an amp meter, a volt meter, a power supply, and so forth.

In one example, the truck 1535 can drag or push a rolling conductive drum 1520b or cylinder along the ground adjacent to the canal 1515. The drum can include spikes which can be inserted into the ground as the drum is rolled along the ground. The drum can also be water filled and the spikes can continuously leaking water from the drum to the ground so that the electric contact between the drum and the ground can be maintained at the optimum. The drum can be the mobile anchor electrode and can introduce the electric current from canal water to the ground along which the drum is rolled. The drum can be electrically coupled to the system management unit 1540 for monitoring the electric current.

In some examples, a spiked drum 1520b may be unable to provide a good electric contact to the ground for adequate measurement. Thus, holes can be dug in the ground at predetermined distances (indicated by marks 1530), and a mobile anchor electrode can be lowered into the holes. Measurements can then be obtained using the system management unit 1540.

In another example, a spring 1510, lake, canal, or other body of water (above or below ground) can provide a second body of water in which the mobile anchor electrode 1520a can be pushed or pulled concurrently with the mobile electrode assembly 1525. The mobile anchor electrode can be pushed or pulled by a same or different mechanism as is used for the mobile electrode assembly. To maintain a desired position (e.g., in the center of the body of water or near a possible leak between two bodies of water), a tether or other device may be attached to the cables going from the truck to the mobile electrodes. The tether can be attached to the truck or can be operated by a user walking alongside the canal or other body of water.

Where previously described examples used a fixed anchor electrode, long cables may be used to move the mobile electrode assembly along a body of water. However, in implementations where both the anchor electrode and the electrode assembly are mobile, the system can be more compact and avoid the use of very long cables. The entire assembly can be moved, set up, and operated from a truck or other mobility device, for example.

FIG. 16 illustrates graphs of example circuit amperage and voltage measurements. The vertical axis of the circuit amperage graph represents an electric current strength. The horizontal axis of the circuit amperage graph represents distance along the body of water. As indicated in the circuit amperage graph, a wider seepage area can be indicated by measurements of electric current signal strength rising and falling over a longer distance. A narrower seepage area can be indicated by measurements of electric current signal strength rising and falling over a shorter distance. Also, an area of greater seepage can be indicated by stronger electric current measurements.

The vertical axis of the voltage graph represents the potential difference measured by the lead and lag electrodes. The horizontal axis represents distance along the body of water. Similar to the circuit amperage graph, a wider seepage area can be indicated by a voltage crossover over a longer distance. A narrower seepage area can be indicated by a voltage crossover over a shorter distance.

The methods and systems of certain examples may be implemented in hardware, software, firmware, or combinations thereof In one example, the method can be executed by software or firmware that is stored in a memory and that is executed by a suitable instruction system. If implemented in hardware, as in an alternative example, the method can be implemented with any suitable technology that is well known in the art.

The various engines, tools, or modules discussed herein may be, for example, software, firmware, commands, data files, programs, code, instructions, or the like, and may also include suitable mechanisms.

Other variations and modifications of the above-described examples and methods are possible in light of the foregoing disclosure. Further, at least some of the components of an example of the technology may be implemented by using a programmed general purpose digital computer, by using application specific integrated circuits, programmable logic devices, or field programmable gate arrays, or by using a network of interconnected components and circuits. Connections may be wired, wireless, and the like.

It will also be appreciated that one or more of the elements depicted in the drawings/figures can also be implemented in a more separated or integrated manner, or even removed or rendered as inoperable in certain cases, as is useful in accordance with a particular application.

Also within the scope of an example is the implementation of a program or code that can be stored in a machine-readable medium to permit a computer to perform any of the methods described above.

Additionally, the signal arrows in the Figures are considered as exemplary and are not limiting, unless otherwise specifically noted. Furthermore, the term “or” as used in this disclosure is generally intended to mean “and/or” unless otherwise indicated. Combinations of components or steps will also be considered as being noted, where terminology is foreseen as rendering the ability to separate or combine is unclear.

Various functions, names, or other parameters shown in the drawings and discussed in the text have been given particular names for purposes of identification. However, the functions, names, or other parameters are only provided as some possible examples to identify the functions, variables, or other parameters. Other function names, parameter names, etc. may be used to identify the functions, or parameters shown in the drawings and discussed in the text.

Some of the functional units described in this specification have been labeled as modules, in order to more particularly emphasize their implementation independence. For example, a module may be implemented as a hardware circuit comprising custom VLSI (Very Large Scale Integration) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

While the forgoing examples are illustrative of the principles of the present technology in one or more particular applications, it will be apparent to those of ordinary skill in the art that numerous modifications in form, usage and details of implementation can be made without the exercise of inventive faculty, and without departing from the principles and concepts of the technology. Accordingly, it is not intended that the technology be limited, except as by the claims set forth below.

1. A system for detecting a location of a subsurface water channel, comprising:
an anchor electrode for disposal in a first body of water;
a mobile electrode for disposal in a second body of water;
an electric current source coupled to at least one of the mobile electrode and the anchor electrode to generate an electric current between the mobile electrode and the anchor electrode;
a lead line coupled to the mobile electrode to enable the mobile electrode to move a distance in the second body of water; and
an ammeter coupled to measure the electric current.

2. The system of claim 1, further comprising a processor operable to compare the electric current with the length of the lead line to determine the location of the subsurface water channel.

3. The system of claim 1, further comprising a line meter coupled to the lead line to measure a length of the lead line from the line meter to the mobile electrode.

4. The system of claim 1, further comprising a data logger coupled to the ammeter to log the current.

5. The system of claim 1, further comprising a head coupled to the lead line near the mobile electrode to enable the mobile electrode to float.

6. The system of claim 1, wherein the mobile electrode comprises a stainless steel ball coupled to the lead line.

7. The system of claim 6, wherein the mobile electrode comprises a plurality of stainless steel balls coupled to the lead line.

8. The system of claim 1, wherein the mobile electrode comprises a plurality of mobile electrodes, the plurality of mobile electrodes including a current electrode, a lead potential electrode, and a lag potential electrode.

9. The system of claim 8, further comprising a voltmeter coupled to the lead potential electrode and the lag potential electrode to measure voltage between the lead potential electrode and the lag potential electrode, wherein the voltage change based on a direction and a level of the electric current from the mobile electrode to the anchor electrode.

10. The system of claim 9, wherein the data logger logs the voltage and the processor is further operable to compare the voltage with the length of the lead line to determine the location of the subsurface water channel.

11. The system of claim 10, wherein the processor is further operable to compare the electric current with the voltage to determine the location of the subsurface water channel.

12. The system of claim 1, wherein the first body of water comprises a spring and the second body of water comprises an underground aqueduct, wherein a channel or leak from the underground aqueduct generates the spring.

13. The system of claim 1, wherein the electric current comprises a direct current.

14. The system of claim 1, wherein the electric current comprises an alternating current.

15. A system for detecting a location of a subsurface water channel, comprising:
an anchor electrode for disposal in a first body of water;
a plurality of mobile electrodes for disposal in a second body of water, the plurality of mobile electrodes comprising a current electrode, a lead potential electrode, and a lag potential electrode;
an electric current source coupled to the current electrodes to generate an electric current between the current electrode and the anchor electrode;
a lead line coupled to the plurality of mobile electrodes to enable the plurality of mobile electrodes to move a distance in the second body of water;
a voltmeter coupled to the lead potential electrode and the lag potential electrode to measure voltage between the lead potential electrode and the lag potential electrode, wherein the voltage changes based on a direction and a level of the electric current between the mobile electrode and the anchor electrode.

16. The system of claim 15, further comprising a processor operable to compare the voltage with the length of the lead line to determine the location of the subsurface water channel.

17. The system of claim 15, further comprising a line meter coupled to the lead line to measure a length of the lead line from the line meter to the mobile electrode.

18. The system of claim 17, further comprising a data logger coupled to the line meter and the voltmeter to log the length of the lead line and the voltage.

19. The system of claim 15, further comprising a head coupled to the lead line near the mobile electrode to enable the mobile electrode to float.

20. The system of claim 15, wherein the plurality of mobile electrodes comprises stainless steel balls coupled to the lead line.

21. The system of claim 20, wherein each of the plurality of mobile electrodes comprises a plurality of stainless steel balls coupled to the lead line.

22. The system of claim 15, further comprising an ammeter coupled to the anchor electrode to measure the electric current from the mobile electrode.

23. The system of claim 16, wherein the data logger is coupled to the ammeter to log the electric current and the processor is further operable to compare the current with the length of the lead line to determine the location of the subsurface water channel.

24. The system of claim 23, wherein the processor is further operable to compare the electric current with the voltage to determine the location of the subsurface water channel.

25. A method for detecting a location of a water pathway deviation, comprising:
disposing an anchor electrode in a first body of water;
disposing a mobile electrode in a flowing second body of water in fluid communication with a water pathway deviation, said water pathway deviation also in fluid communication with the first body of water;
generating an electric current between the mobile electrode and the anchor electrode along the water pathway deviation;
moving the mobile electrode along a distance in the flowing second body of water past the water pathway deviation; and
measuring changes in electric current between the mobile electrode and the anchor electrode as a function of the distance.

26. The method of claim 25, further comprising mapping the electric current on a graph as a function of the distance.

27. The method of claim 25, further comprising identifying an increase in the electric current and a decrease in the electric current as a function of the distance.

28. The method of claim 27, further comprising isolating an electric current peak where the increase in the current stops increasing before changing into the decrease in the current.

29. The method of claim 28, further comprising identifying a leak location in the second body of water based on the distance at the electric current peak.

30. The method of claim 25, wherein the second body of water comprises at least one of an underground aqueduct, a dike, or a canal, and the first body of water comprises at least one of a well and a spring.

31. A method for electric admittance mapping using moving electrodes to detect a location of a water pathway deviation, comprising:
disposing an anchor electrode in a first body in fluid communication with the water pathway deviation;
disposing a plurality of mobile electrodes in a flowing second body of water in fluid communication with the water pathway deviation, the plurality of mobile electrodes comprising a current electrode, a lead potential electrode, and a lag potential electrode;
generating an electric current between the current electrode and the anchor electrode along the water pathway deviation;
moving the plurality of mobile electrodes with a fluid flow in the flowing second body of water and along a distance in the flowing second body of water past the water pathway deviation; and
measuring a potential difference across the lead potential electrode and the lag potential electrode as a function of the distance.

32. A method for electric admittance mapping using moving electrodes to detect a subsurface water pathway, comprising:
disposing an anchor electrode in a first body of water;
disposing a plurality of mobile electrodes in a second body of water, the plurality of mobile electrodes comprising a current electrode, a lead potential electrode, and a lag potential electrode;
generating an electric current between the current electrode and the anchor electrode along the subsurface water pathway;
moving the plurality of mobile electrodes along a distance in the second body of water past the subsurface water pathway; and
measuring a potential difference across the lead potential electrode and the lag potential electrode as a function of the distance.

33. The method of claim 32, further comprising mapping the potential difference on a graph as a function of the distance.

34. The method of claim 32, further comprising identifying an area of positive potential difference and an area of negative potential difference from the potential difference measured.

35. The method of claim 32, further comprising determining a potential difference cross-over where the positive potential difference changes to the negative potential difference.

36. The method of claim 35, further comprising identifying a leak location in the second body of water based on the distance at the potential difference cross-over.

37. The method of claim 32, further comprising measuring the electric current between the current electrode and the anchor electrode.

38. The method of claim 37, further comprising mapping the electric current on a graph as a function of distance.

39. The method of claim 38, further comprising identifying an increase in the electric current and a decrease in the current as a function of the distance.

40. The method of claim 39, further comprising isolating an electric current peak where the increase in the current stops increasing before changing into the decrease in the current.

41. The method of claim 40, further comprising identifying a leak location in the second body of water based on the distance at the electric current peak.

42. The method of claim 37, further comprising mapping the electric current and the potential difference together on a graph.

43. The method of claim 42, further comprising comparing a potential difference cross-over with an electric current peak as a function of the distance.

44. The method of claim 43, further comprising identifying a leak location in the second body of water based on the comparison of the potential difference cross-over with the electric current peak.

45. The method of claim 32, further comprising the step of moving the anchor electrode within the first body of water.
